(19) United States
(12) Patent Application Publication
(10) Pub. No.: US 2017/0364898 A1
(43) Pub. Date: Dec. 21, 2017

(54) MOBILE PAYMENT SYSTEM AND METHOD

(71) Applicant: SocialPay LLC, Cincinnati, OH (US)

(72) Inventors: Roger Ach, II, Cincinnati, OH (US); Daniel Cox, Cincinnati, OH (US); Chris Burnett, Cincinnati, OH (US)

(73) Assignee: SocialPay LLC, Cincinnati, OH (US)

(21) Appl. No.: 15/622,259

(22) Filed: Jun. 14, 2017

Related U.S. Application Data
(60) Provisional application No. 62/350,375, filed on Jun. 15, 2016.
(60) Provisional application No. 62/436,048, filed on Dec. 19, 2016.
(60) Provisional application No. 62/467,912, filed on Mar. 7, 2017.

(51) Int. Cl. G06Q 20/32; G06Q 20/40; G06Q 20/02

(52) U.S. Cl. CPC G06Q 20/3223; G06Q 20/02; G06Q 20/4014

(57) ABSTRACT

A mobile payment system (MPS) is disclosed that enables transactions for MPS users using user devices, and interfaces with third party payment systems with third party user accounts. The MPS includes MPS frontends, third party MPS accounts, and a MPS backend including a MPS backend account, a MPS database and MPS user accounts. Each MPS frontend is located on one user device and is associated with one MPS user. At least one of the third party MPS accounts is on each third party payment system. Each MPS user account is associated with at least one MPS user. A particular MPS frontend performs local processing of MPS functions on its user device and communicates over networks with the MPS backend and with other MPS frontends on other user devices. The MPS backend administers funds in the MPS backend account, the MPS user accounts, and the third party MPS accounts.

### CROSS-REFERENCE TO RELATED APPLICATIONS

This application claims priority to U.S. Provisional Patent Application Ser. No. 62/350,375, filed Jun. 15, 2016 entitled “MOBILE PAYMENT SYSTEM AND METHOD”, and to U.S. Provisional Patent Application Ser. No. 62/436,048, filed Dec. 19, 2016 entitled “MOBILE PAYMENT SYSTEM AND METHOD”, and also to U.S. Provisional Patent Application Ser. No. 62/467,912, filed Mar. 7, 2017 entitled “MOBILE PAYMENT SYSTEM AND METHOD”, the disclosures of which are all expressly incorporated herein by reference.

### FIELD OF THE DISCLOSURE

The present disclosure relates to payment systems and methods, and more particularly to a mobile payment system and method that integrates third party payment networks, mobile banking environments and merchant payment systems.

### BACKGROUND

Financial technology is growing rapidly, with increasing numbers of disruptive technologies entering the market that are affecting the way consumers interact with financial services providers. Banks and many other financial service providers have massive, entrenched and inefficient infrastructure that make change and upgrades difficult. Today's consumers expect their financial experiences to be mobile, personalized, customizable and accessible, including when it comes to making and receiving payments. There are numerous established and emerging mobile payment networks with little or no interactivity between these different payment networks available to consumers.

It would be desirable to have a mobile and accessible payment service that interfaces well with various different payment networks to give users the freedom of seamless payments whether the payee and payer are on the same or different payment networks.

### SUMMARY

A mobile payment system can create a digital bridge between and among major mobile payment peer-to-peer (P2P) applications (for example, PayPal®, Dwolla, Venmo, Google Wallet, Square, etc.) and mobile platforms at major banks (for example, Chase QuickPay, etc.) to create an open-loop, interoperable payment system.

A mobile payment system (MPS) method is disclosed that enables transactions for a plurality of MPS users using a plurality of user electronic devices. The MPS method includes installing a MPS frontend on each of the plurality of user electronic devices, where each MPS frontend performs local processing of MPS functions on the user electronic device on which that MPS frontend is installed. The MPS method includes associating each of the MPS frontends with one of the MPS users and with one of the plurality of user electronic devices. The MPS method includes interfacing with a plurality of third party payment systems that each have a plurality of third party user accounts; and establishing a third party MPS account on each of the third party payment systems. The MPS method includes creating a MPS backend comprising a MPS backend account, a MPS database and a plurality of MPS user accounts where each of the plurality of MPS user accounts is associated with at least one of the MPS users. The MPS method also includes communicating over networks between the MPS backend and each of the MPS frontends and each of the third party payment systems, and communicating over the networks between each of the MPS frontends. The MPS method includes transferring funds between the MPS user accounts and third party user accounts as directed by the plurality of MPS users; and controlling the transfer of funds between the MPS backend account, the plurality of third party MPS accounts, the MPS user accounts and third party user accounts. The mobile payment system method can also include associating each of the plurality of MPS user accounts with at least one of the third party user accounts on the third party payment systems.

The mobile payment system method can also include establishing a new MPS user by enabling the new MPS user to download a MPS frontend to a user electronic device associated with the new MPS user; and accepting user profile information from the new MPS user through the MPS frontend where the user profile information includes user identification information, user contact information, and a user phone number associated with the user electronic device associated with the new MPS user. Establishing a new MPS user also includes sending the user profile information from the MPS frontend to the MPS backend; storing the user profile information in the MPS database. If the new MPS user provides a third party user account, establishing a new MPS user also includes establishing a new MPS user account and associating the new MPS user account with the third party user account provided by the new MPS user. If the new MPS user does not provide a third party user account, establishing a new MPS user also includes walking the new MPS user through establishing a new third party user account; establishing a new MPS user account and associating the new MPS user account with the new third party user account of the new MPS user. Establishing a new MPS user also includes generating user authentication data associated with the new MPS user. The user authentication data can be based on the user phone number associated with the user electronic device associated with the new MPS user.

The MPS functions can include a transfer funds function for transferring funds from a sender MPS user to a recipient. The transfer funds function includes displaying a transaction interface on the MPS frontend associated with the sender MPS user; enabling the sender MPS user to enter a recipient identifier, a transfer amount and a payment method into the transaction interface; enabling the sender MPS user to submit the transfer request by sending the recipient identifier, the transfer amount and the payment method from the MPS frontend associated with the sender MPS user to the MPS backend; and confirming a sender account associated with the sender MPS user has sufficient funds for transfer of the transfer amount from the sender account. If the sender account has sufficient funds, then the transfer funds function also includes determining the recipient from the recipient identifier; transferring the transfer amount from the sender account; transferring the transfer amount to a recipient account associated with the recipient; sending a sender confirmation message to the sender MPS user; and sending a recipient confirmation message to the recipient. If the sender account does not have sufficient funds, then the transfer funds function also includes sending a cancel notice to the sender MPS user. If the recipient identifier is a recipient phone number, and if the sender account has sufficient funds, then determining the recipient from the recipient identifier can include sending a new transfer message using the recipient phone number, where the new transfer message includes instructions on how to retrieve the transfer amount; waiting for a response to the new transfer message; and determining the recipient account based on the response to the new transfer message. The new transfer message can include instructions on how to open a new MPS user account and instructions on how to transfer the transfer amount to an existing MPS user account or third party user account. If the response to the new transfer message is to open a new MPS user account, then determining the recipient account comprises downloading a MPS frontend to an electronic device associated with the recipient; accepting user profile information from the recipient through the MPS frontend; storing the user profile information in the MPS database; opening a recipient MPS user account associated with the recipient; and transferring the transfer amount to the recipient MPS user account. If the response to the new transfer message is to transfer the transfer amount to an existing MPS user account, then determining the recipient account based on the response to the new transfer message comprises accepting an MPS user identifier and recipient user authentication information for the existing MPS user account; confirming the recipient user authentication information matches stored user authentication information for the existing MPS user account; and if the recipient user authentication information matches, then transferring the transfer amount to the existing MPS user account. If the response to the new transfer message is to transfer the transfer amount to a third party user account, then determining the recipient account based on the response to the new transfer message comprises accepting a third party user account identifier; and attempting to transfer the transfer amount to a third party user account associated with the third party user account identifier.

If the recipient identifier identifies a recipient associated with a recipient MPS user account of the plurality of MPS user accounts, and if the sender account has sufficient funds, then transferring the transfer amount to a recipient account comprises transferring the transfer amount into the recipient MPS user account; and sending a recipient confirmation message comprises sending the recipient confirmation message to a user phone number associated with the recipient MPS user account.

If the payment method is associated with a sender third party payment system of the plurality of third party payment systems, then confirming a sender account associated with the sender MPS user has sufficient funds comprises determining a sender third party user account on the sender third party payment system that is associated with the sender MPS account, and confirming that the sender third party user account has sufficient funds for transfer of the transfer amount from the sender third party user account. If the sender third party user account has sufficient funds, then transferring the transfer amount from the sender account comprises requesting a first transfer of the transfer amount from the sender third party user account to a sender third party MPS account, where the sender third party MPS account is on the sender third party payment system and is one of the plurality of third party MPS accounts; and not transferring the transfer amount to the recipient account until after the first transfer is confirmed.

The transfer funds function can also include determining a transaction fee for the transfer request; and confirming the sender account has sufficient funds for transfer out of both the transfer amount and the transaction fee. If the sender account has sufficient funds for transfer out of both the transfer amount and the transaction fee, then before transferring any funds or sending any confirmation messages, the transfer funds function can include asking the sender MPS user for acceptance of the transaction fee. If the sender MPS user does not accept the transaction fee, the transfer funds function can include sending a cancel notice to the sender MPS user. If the sender MPS user accepts the transaction fee, the transfer funds function can include proceeding with transferring funds and sending confirmation messages.

The transfer funds function can also include before transferring any funds or sending any confirmation messages, requesting entry of sender authentication information from the sender MPS user; and comparing the entered sender authentication information with stored authentication information associated with the sender MPS user account. If the entered sender authentication information matches the stored authentication information associated with the sender MPS user account, the transfer funds function can include proceeding with the transaction request. If the entered sender authentication information does not match the stored authentication information associated with the sender MPS user account, the transfer funds function can include not proceeding with the transaction request.

The MPS functions can include a transfer funds function for transferring funds from a sender MPS user to a recipient MPS user of the plurality of MPS users. The transfer funds function can include displaying a transaction interface on the MPS frontend associated with the sender MPS user; enabling the sender MPS user to enter a recipient identifier, a transfer amount and a sender payment method into the transaction interface, where the recipient identifier is associated with the recipient MPS user. The transfer funds function can also include enabling the sender MPS user to submit the transfer request by sending the recipient identifier, the transfer amount and the sender payment method from the MPS frontend associated with the sender MPS user to the MPS backend; and determining a sender user account on the sender payment system identified by the sender payment method, where the sender user account is one of a sender MPS account associated with the sender MPS user when the sender payment method identifies the MPS system or a sender third party user account associated with the sender MPS user account where the sender payment method identifies the third party payment system. The transfer funds function also includes confirming the sender user account has sufficient funds for transfer of the transfer amount from the sender user account. If the sender account has sufficient funds, then the transfer funds function also includes sending a payment request to the MPS frontend associated with the recipient MPS user; enabling the recipient MPS user to enter a recipient payment method into the payment request; enabling the recipient MPS user to submit a response to the payment request with the recipient payment method; and determining a recipient user account identified by the recipient payment method. The recipient user account is one of a recipient MPS account associated with the recipient MPS user when the recipient payment method identifies the MPS system, or a recipient third party user account associated with the recipient MPS user account where the recipient payment method identifies a third party payment system. If the sender account has sufficient funds and the recipient MPS user submits the response to the payment request, then the transfer funds function also includes transferring the transfer amount from the sender user account; transferring the transfer amount to the recipient user account; sending a sender confirmation message to the sender MPS user; and sending a recipient confirmation message to the recipient MPS user. If the sender account does not have sufficient funds or the recipient MPS user does not submit the response to the payment request, then the transfer funds function also includes sending a cancel notice to the sender MPS user.

When the sender user account is a sender third party user account on a sender third party payment system identified by the sender payment method, and the recipient user account is a recipient third party user account on a recipient third party payment system identified by the recipient payment method, and the sender third party payment system is different from the recipient third party payment system, the steps of transferring the transfer amount from the sender user account and transferring the transfer amount to the recipient user account comprise: initiating a first transfer of the transfer amount from the sender user account to a sender third party MPS account; waiting for a confirmation of the first transfer; and after the confirmation of the first transfer, initiating a second transfer of the transfer amount from a recipient third party MPS account to the recipient user account/The sender third party MPS account is on the sender third party payment system and is one of the plurality of third party MPS accounts. The recipient third party MPS account is on the recipient third party payment system and is one of the plurality of third party MPS accounts.

When the sender user account is a sender third party user account on a sender third party payment system identified by the sender payment method, and the recipient user account is a recipient third party user account on the sender third party payment system identified by the recipient payment method, the steps of transferring the transfer amount from the sender user account and transferring the transfer amount to the recipient user account comprise: initiating a first transfer of the transfer amount from the sender user account to a sender third party MPS account; waiting for a confirmation of the first transfer; and after the confirmation of the first transfer, initiating a second transfer of the transfer amount from the sender third party MPS account to the recipient user account. The sender third party MPS account is on the sender third party payment system and is one of the plurality of third party MPS accounts.

The MPS functions can include an event function for an organizer of the plurality of MPS users to invite one or more invitees, where each of the invitees is one of the plurality of MPS users. The event function can include displaying an event organizer interface on the MPS frontend associated with the organizer; enabling the organizer to enter an event name, an event description and an event amount using the event organizer interface; enabling the organizer to build an invitee list using the event organizer interface; and enabling the organizer to submit a request to send invitations from the event organizer interface on the MPS frontend associated with the organizer to the MPS backend; along with the event name, the event description, the event amount, and the invitee list. The event function can also include establishing an event MPS account on the MPS backend; sending an invitation from the MPS backend to the MPS frontend associated with each of invitees on the invitee list, where the invitation includes the event name, the event description and the event amount; for each invitee, and displaying the invitation along with an invite accept selection and an invite decline selection on the MPS frontend associated with the invitee. If the invitee selects the invite accept selection; the event function also includes sending an invite accept notice from the invitee frontend to the MPS backend, initiating a funds transfer from the MPS user account associated with the invitee to the event MPS account, and sending an acceptance notice for the invitee to the MPS frontend associated with the organizer. If the invitee selects the invite decline selection; the event function also includes sending an invite decline notice from the invitee frontend to the MPS backend, and sending a decline notice for the invitee to the MPS frontend associated with the organizer.

The MPS functions can include a payment request for a paying MPS user to pay a recipient. The payment request function can include displaying a payment interface on the MPS frontend associated with the paying MPS user; enabling the paying MPS user to enter a recipient identifier, a payment amount and a payment method into the payment interface; enabling the paying MPS user to submit the payment request by sending the recipient identifier, the payment amount and the payment method from the MPS frontend associated with the paying MPS user to the MPS backend; and enabling the paying MPS user to request an MPS loan. If the paying MPS user requests an MPS loan, then the payment request function also includes determining a recipient based on the recipient identifier; and determining whether to offer an MPS loan or deny the MPS loan request based on the recipient, the payment amount and profile information associated with the paying MPS user. If it is determined to deny the MPS loan request, then the payment request function also includes notifying the paying MPS user of denial of the MPS loan request. If it is determined to offer an MPS loan in response to the MPS loan request, then the payment request function also includes determining loan interest rate, origination fee, monthly payment amount, number of monthly payments, and terms and conditions based on the recipient, the payment amount and profile information associated with the paying MPS user; and notifying the paying MPS user of the MPS loan offer along with the loan interest rate, origination fee, monthly payment amount, number of monthly payments, and terms and conditions of the MPS loan offer. If the paying MPS user accepts the MPS loan offer, then the payment request function also includes initiating a first funds transfer of the payment amount directly to the recipient, and initiating a second funds transfer of the origination fee from a user account associated with the paying MPS user to the MPS bank account or one of the plurality of third party MPS accounts. If the paying MPS user accepts the MPS loan offer, then the payment request function can also include setting up a monthly recurring payment of the monthly payment amount from the user account associated with the paying MPS user to the MPS bank account or one of the plurality of third party MPS accounts to occur each month for the number of monthly payments.

A mobile payment system (MPS) is disclosed that enables transactions for a plurality of MPS users using a plurality of user electronic devices, where the mobile payment system interfaces with a plurality of third party payment systems that have a plurality of third party user accounts. The mobile payment system includes a plurality of MPS frontends, a plurality of third party MPS accounts, and a MPS backend comprising a MPS backend account, a MPS database and a plurality of MPS user accounts. Each of the MPS frontends is located on one of the plurality of user electronic devices, and each of the MPS frontends is associated with one of the MPS users. At least one of the third party MPS accounts is on each of the third party payment systems. Each of the MPS user accounts is associated with at least one of the MPS users. Any particular MPS frontend of the plurality of MPS frontends is located on a particular user electronic device of the plurality of user electronic devices, the particular MPS frontend performs local processing of MPS functions on the particular user electronic device and communicates over a network with the mobile payment system backend and with other MPS frontends of the plurality of MPS frontends on other user electronic devices of the plurality of user electronic devices. The MPS backend administers funds in the MPS backend account, the plurality of MPS user accounts, and the plurality of third party MPS accounts. Each of the plurality of MPS user accounts on the MPS backend can be associated with at least one of the third party user accounts on the third party payment systems. The MPS database can include authentication data for each of the MPS users, and the authentication data for a certain MPS user of the plurality of MPS users can be based on a mobile phone number associated with a certain user electronic device of the plurality of user electronic devices where the MPS frontend associated with the certain MPS user is located on the certain user electronic device.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates an example environment for a mobile payment system and a top-level view of components of an exemplary embodiment of a mobile payment system;

FIG. 2 illustrates an example transaction interface brought up by a MPS frontend on an electronic device for a sender client (payer) to send money to a recipient client (payee);

FIG. 3 illustrates an example transaction record for a client of the mobile payment system;

FIG. 4 illustrates an exemplary event organizer screen for event planning functionality;

FIG. 5 illustrates an exemplary event invite screen for the event planning functionality;

FIG. 6 illustrates another exemplary embodiment of an event organizer screen for event planning functionality;

FIG. 7 illustrates an exemplary event summary screen that can be used for event planning functionality;

FIG. 8 illustrates a user device in a messaging application with a link to an extended payment system keyboard that enables funds transfers while in the messaging application;

FIG. 9 illustrates the user device in the messaging application displaying the extended payment system keyboard that enables funds transfers while in the messaging application;

FIG. 10 illustrates an alternative exemplary embodiment of a user device in a text messaging application on a transfer funds screen with a text display area, a virtual keyboard and an alternative exemplary embodiment of an MPS transaction area;

FIG. 11 illustrates an exemplary send funds screen;

FIG. 12 illustrates an exemplary amount entry screen;

FIG. 13 illustrates an exemplary transaction fee acceptance screen;

FIG. 14 illustrates an exemplary user authentication screen using a personal identification number (PIN) to authenticate the user;

FIG. 15 illustrates an alternative example of a transaction interface brought up by a MPS frontend that includes an MPS loan selection; and

FIG. 16 illustrates an exemplary MPS loan application window.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

A mobile payment system and method can interface with third party peer payment networks, mobile banking environments and external public and private application programming interfaces (API's). A mobile payment system and method can be used as a payment service or as a higher-level payment service that gives users the freedom of seamless payments within and between different payment services. The mobile payment system and method can enable various payment types, for example peer-to-peer (P2P) payments, group payments, or merchandise purchases.

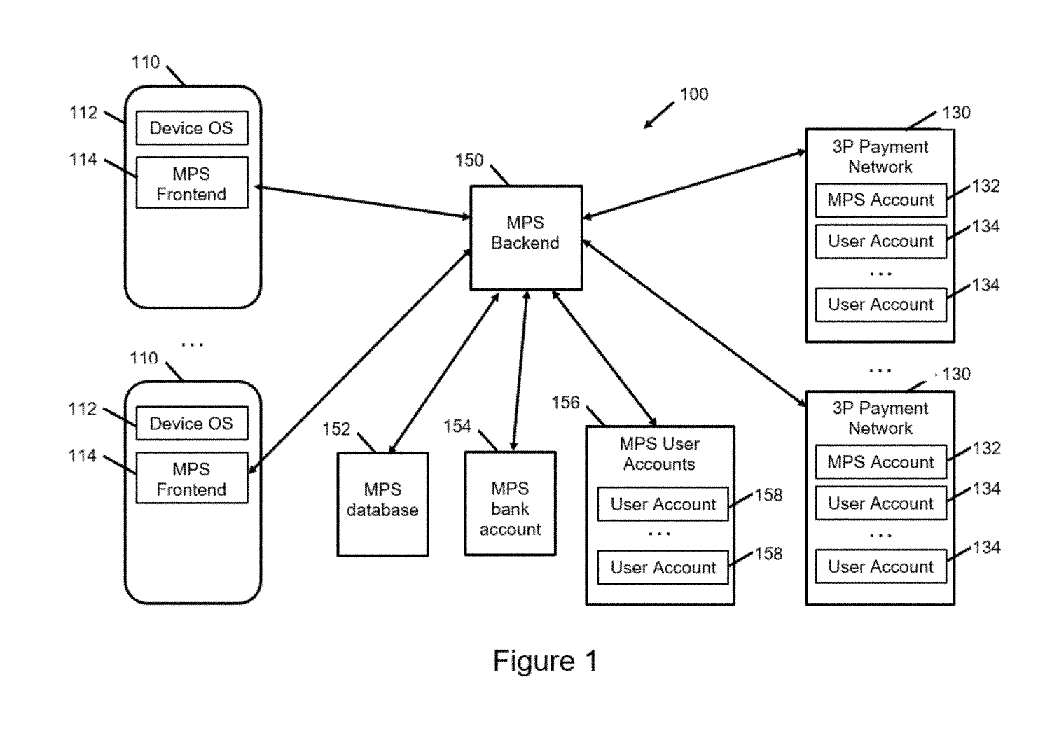

FIG. 1 illustrates an example environment for a mobile payment system 100 and a top-level view of components of an exemplary embodiment of a mobile payment system 100. The environment in FIG. 1 includes a plurality of mobile electronic devices 110, a plurality of third-party payment networks 130 and a mobile payment system (MPS) backend 150. Each of the plurality of mobile electronic devices 110, which can be for example smart phones, tablets or other mobile electronic devices, includes an operating system 112 and a mobile payment system frontend 114. Each of the plurality of third-party (3P) payment networks 130 includes a plurality of commercial and/or personal user accounts which include a mobile payment system (MPS) account 132, and a plurality of other user account 134 some of which can also be users of the mobile payment system 100. The mobile payment system backend 150 includes a mobile payment system database 152, a mobile payment system bank account 154, and mobile payment system user accounts 156 which include a plurality of user deposit accounts 158, one for each client of the mobile payment system 100.

The mobile payment system frontend 114 on each mobile electronic device 110 performs local processing of mobile payment system functions, and communicates externally with the mobile payment system backend 150 and with the mobile payment system frontends 114 on other mobile electronic devices 110. The mobile payment system backend 150 administers the funds in the MPS bank account 154, a plurality of local MPS accounts 132, and the MPS user accounts 156. The mobile payment system bank account 154 is a primary mobile payment system account that can include multiple accounts with one or more financial institutions. The mobile payment system 100 can have a local MPS account 132 on each third party payment network 130 that has a client of the mobile payment system 100. Each client of the mobile payment system 100 has a MPS user account 158, and each MPS user account 158 is connected to a 3P user account 134 for that user on one of the third-party payment networks 130.

Clients can sign up for the mobile payment system 100 using an existing 3P user account 134 with a third-party payment service 130, and connect their existing 3P user account 134 to a new MPS user account 158 on the mobile payment system 100. If a client does not have an existing account with a third-party payment service 130, the mobile payment system 100 can walk the client through new account creation on a selected third-party payment system 130 and connect this new 3P user account 134 to a new MPS user account 158 on the mobile payment system 100. Once a client has gone through the account setup process, they can quickly send and receive payments to/from their peers and businesses, and also purchase goods online or at brick and mortar merchants. By confirming 3P user accounts 134 on established third-party payment networks 130, clients of the mobile payment system 100 are vetted and authorized by these third-party payment networks 130. The MPS user account 158 can be used with the user's personal mobile phone to effect a variety of person-to-person payments as well as to pay bills, rent, mortgage payments, insurance payments, to originate and access providers of personal loans, home mortgage loans and the resulting ongoing payment streams which arise from those transactions. The MPS user account 158 can create a unique and virtual personal financial “cubby” for the user.

Embodiments of the mobile payment system 100 can support payments even before a payee (payment recipient) opens an account. This enables a payer client of the mobile payment system 100 to make a payment to a payee that does not have a MPS user account 158, and enables a payee that does not have a MPS user account 158 to receive a payment through the mobile payment system 100 from a payer client of the mobile payment system 100. The mobile payment system 100 can accept a payment request from the existing payer client to make a payment from the MPS user account 158 or a 3P user account 134 of the payer client, confirm sufficient funds for the payment request, allocate the payment funds, and then confirm payment to the payee by a text message, email message or other method. The message confirming payment to the non-client payee can include an invitation to the payee to download the mobile payment system frontend 114 to an electronic device to retrieve the payment and redirect the funds with or without opening an account on the mobile payment system 100. The message confirming payment to the non-client payee can also include instructions on how to enter their financial account information to retrieve the payment and redirect the funds to their financial account without opening an account on the mobile payment system 100. Existing clients can also search and invite friends and family via their physical and on-line contacts to join the mobile payment system 100 for easy exchange of funds.

The mobile payment system back end 150 can control one or more depositary trust accounts with major banks and financial institutions that compose the MPS bank account 154. The mobile payment system back end 150 can also control a plurality of MPS deposit accounts 132 on various financial platforms, for example banks and third-party payment networks 130. In addition, the mobile payment system back end 150 can control a plurality of MPS user accounts 158, where each MPS user account 158 can be separate from or a mimic/copy of a 3P user account 134 for the client user, for example a bank or third-party payment network 130 account.

The mobile payment system 100 can allow clients to do one or more of the following financial transactions as well as others described herein. The mobile payment system 100 can enable clients to send or receive peer-to-peer (P2P) payments to/from friends, family, contractors, professionals and others across various payment platforms 130. The mobile payment system 100 can enable clients to send or receive payments P2P using mobile devices 110. The mobile payment system 100 can enable clients to multi-source bill pay, where a client can aggregate funds from multiple user accounts 134 on one or more payment platforms 130 into a MPS user account 158 to pay bills and manage debit and credit cards. The mobile payment system 100 can enable clients to multi-source payments to individuals and merchants, where a client can aggregate funds from multiple user accounts 134 on one or more payment platforms 130 into a MPS user account 158 to pay an individual or merchant. The mobile payment system 100 can also enable clients to send and receive P2P payments privately and securely.

The mobile payment system 100 can generate revenue through fees, interest, advertising, coupons and other methods. Fee based revenue streams can include an instant pay transaction fee to allow users to send and receive money across different payment platforms, and a private pay transaction fee to allow users to send and receive money privately without identifying an account of the mobile payment system 100. Money remaining in an individual's MPS account 158 on the mobile payment system 100 can also generate interest income.

The mobile payment system 100 includes administrative functionality that can perform necessary administrative tasks, for example, recording and tracking user transactions, deposits and payments; generating reports; maintaining user profiles and accounts; interfacing with third-party payment networks, and enabling transfers between mobile payment system accounts and various payment network accounts. The administrative functionality can be used for setting up merchant accounts with third party payment networks, integration with bank APIs, logging of transactions, retrieving of transaction information, and sending and receiving of payments.

When a user downloads the mobile payment system frontend 114 to their mobile device 110 and first uses the mobile payment system 100, the mobile payment system frontend 114 can walk the new user through an account setup process where the user creates a user profile that is stored in the MPS database 152. All or portions of the user profile may also be stored in the MPS frontend 114 on the electronic device 110. The user profile can include user identification information (e.g., name, birthdate, address, etc.), user contact information (e.g., email address, secondary phone number, etc.). The user profile also includes a primary user phone number that is associated with the mobile electronic device 110 that hosts the MPS frontend 114. The primary user phone number is tied to the MPS user account 158 for the transfer of funds to/from the user. The user profile can also include an associated 3P user account 134 on a third party payment network 130 that can be tied to the MPS user account 158 for the user. This newly entered user profile information is sent from the user device 110 to the mobile payment system backend 150 which stores the user profile information in the MPS database 152. The mobile payment system backend 150 can also generate a user identifier to uniquely identify the new user of the mobile payment system 100.

The mobile payment system 100 can generate a unique account number for each personal or business MPS account 158. The unique user account number can be based on a mobile phone number and/or Social Security number of the user, which are two numbers that seldom if ever change for an individual. This can enable an embodiment of a mobile payment system 100 that creates a unique and virtual personal financial “cubby” (MPS user account 158) for each user that is centered around their mobile phone number or other easy to remember identifier. The mobile payment system 100 can require all or part of this account number during a user identification process to authenticate a user when logging into and/or performing a transaction on the mobile payment system 100. The user authentication process can also include a personal identification number (PIN), password and/or biometric data, for example, facial recognition, iris scan, fingerprint recognition, etc. The user authentication process can also include voice commands that check for certain code words and/or confirm the user's voice. A similar combination of security safeguards can be used for system access, sending of funds and/or receipt of funds. The mobile payment system 100 can retain records of the user authentication process, whether successful or not. The mobile payment system 100 can lock an account after repeated authentication process failures or other suspicious activity.

The mobile payment system 100 can enable a variety of funds transfers and accounting transactions. One of the basic transactions is a sender client (payer) sending money to a recipient client (payee). The recipient can be on the same payment network 130 as the sender or on another payment network 130. When the mobile payment system 100 has a transaction where the payer and payee clients have user accounts 134 that are in the same financial platform 130, the mobile payment system 100 can transfer the funds between the payer and payee user accounts 134 within that financial platform 130 to create a quick payment option for clients. There are a number of transactions that occur when funds are moved from the payer's account to the recipient's account.

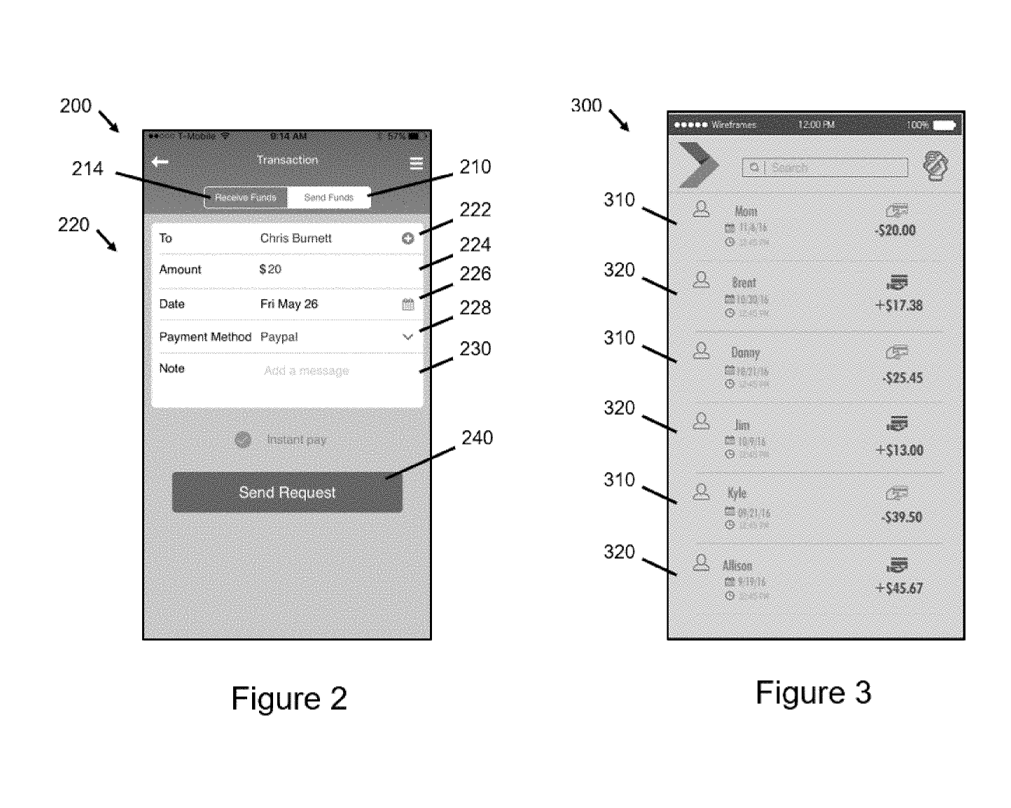

FIG. 2 illustrates an example of a transaction interface 200 brought up by a MPS frontend 114 on an electronic device 110 of a user of the mobile payment system 100 for a sender client (payer) sending money to a recipient client (payee). The transaction interface 200 includes a Send Funds selection 210, a Receive Funds selection 214 and a transaction details section 220. A client user can use the Send Funds selection 210 when the client user wants to transfer funds to another person. A client user can use the Receive Funds selection 214 when the client user wants to send a request to another user to transfer funds to the client person.

In the case shown in FIG. 2, the Send Funds selection 210 is selected which displays the following fields in the transaction details section 220: a recipient field 222, an amount field 224, a transaction date field 226, a payment method field 228 and a note or memo field 230. The sender client information for this transaction automatically defaults to the user profile information associated with the electronic device 110 of the sender client that brought up the transaction interface 200. The sender client can enter a recipient user name into the recipient field 222. The mobile payment system frontend 114 can list potential matches as the sender enters the recipient name. If no client match is found for the name entered in the recipient field 222, the mobile payment system frontend 114 can list alternatives for selection by the sender client, or provide a warning that no matching recipient client was found. The sender client enters a payment amount in the amount field 224. The sender client enters a transaction date for the funds to be transferred in the date field 226. The mobile payment system frontend 114 can bring up today's date as a default, and allow the sender client to select a date using a calendar if they want to change the transaction date. The sender client enters a payment method in the payment method field 228. The mobile payment system frontend 114 can provide a drop down menu of available payment methods for the sender client to choose between. The payment methods available to a sender client will only include payment network accounts or bank accounts that the sender client has associated with their mobile payment system account 158 through their profile stored in the mobile payment system database 152. The sender client can optionally enter a note or memo regarding the transaction in the note field 230. After the necessary transaction information is entered in the transaction details section 220, the sender client can select the Send Request button 240 to submit the transaction to the mobile payment system 100 for funds transfer.

When the sender has an associated user account 134S and the recipient has an associated user account 134R on the same payment network 130, then the funds can stay within that payment network 130. The mobile payment system 100 can initiate a funds transfer from the sender's user account 134S to the recipient's user account 134R within the same payment network 130. The mobile payment system 100 could use the sender and recipient profile information in the MPS database 152, access an interface with that payment network 130 to initiate a lookup of the sender's user account 134S and the recipient's user account 134R, and create a transaction on the payment network 130 to transfer the funds from the sender's user account 134S to the recipient's user account 134R on the payment network 130. The mobile payment system 100 could then wait for a confirmation of the transfer from the payment network 130, and send confirmations to the sender and the recipient. The mobile payment system 100 can charge a transaction fee to the sender and/or the recipient which would move funds from the appropriate user account(s) 134 to the MPS account 132 on the payment network 130. When both sender and recipient are on the same payment network 130, funds transferred between the sender's user account 134S and the recipient's user account 134R do not need to move through the MPS account 132 to complete the transaction.

When the sender and recipient are on different payment networks 130, funds can flow through one or more of the mobile payment system (MPS) accounts 132. For example, assume the sender has a sender user account 134S on a first payment network 130S that has a first MPS account 132S, and the recipient has a recipient user account 134R on a second payment network 130R that has a second MPS account 132R. The mobile payment system backend 150 can initiate a first funds transfer on the sender's payment network 130S to transfer funds from the sender user account 134S to the first MPS account 132S. The mobile payment system backend 150 can then wait until confirmation is received that this first funds transfer is complete. When confirmation is received that the first funds transfer is complete, then the mobile payment system backend 150 can initiate a funds transfer from the second MPS account 132R to the recipient user account 134R on the recipient's payment network 130R. The mobile payment system backend 150 can confirm that the funds transfer is received from the sender's user account 134S into the first MPS account 132S by several methods, for example, the mobile payment system backend 150 can wait for a confirmation from the first payment network 130S of the deposit into the first MPS account 132S from the sender user account 134S, or the mobile payment system backend 150 can poll the first MPS account 132S (e.g., once per minute) until it can match a transaction receipt with the transfer of funds from the sender user account 134S. After the mobile payment system confirms that the funds are received from the sender, the mobile payment system backend 150 can interface with the recipient's payment network 130R. The mobile payment system backend 150 can search for and select the recipient and the recipient's payment network 130R based on the recipient's account profile information in the mobile payment system 100. The mobile payment system backend 150 can then interface with recipient's payment network 130R, and initiate a send funds transaction from the second MPS account 132R to the recipient's user account 134R. The mobile payment system 100 can use one of its accounts on the recipient's payment network 130R to increase the speed of this transaction.

The mobile payment system 100 can charge a transaction fee to the sender which would move funds from the sender's user account 134S to the MPS account 132S on the sender's payment network 130S. The mobile payment system 100 can handle payment of the transaction fee on the sender's payment network 130S as a funds request with the MPS account 132S as the recipient, or as another send funds transaction from the sender's user account 134S to the MPS account 132S using a transaction interface with the payment network 130S. This will be a second transaction on the sender's payment network 130S where funds are sent from the sender's user account 134S to the MPS account 132S in the amount of the transaction fee. The mobile payment system 100 can wait for confirmations of all of the transfers on the sender and recipient payment networks 130S and 130R and then send confirmations to the sender and the recipient, or the mobile payment system 100 can send confirmations to the affected parties as each of the transfers is confirmed on the relevant payment network 130S, 130R.

FIG. 3 illustrates an example of a transaction record 300 for a client of the mobile payment system 100. The transaction record 300 includes Send Funds transactions 310 and Receive Funds transactions 320. Each Send Funds transaction 310 includes a recipient name, a transaction date and time and a payment outgo amount. Each Receive Funds transaction 320 includes a sender name, a transaction date and time and a payment income amount. The transaction record 300 can be scrollable so that additional Send Funds and Receive Funds transactions 310, 320 can be viewed. The transaction record 300 can be sorted and filtered based on the fields of the transaction records.

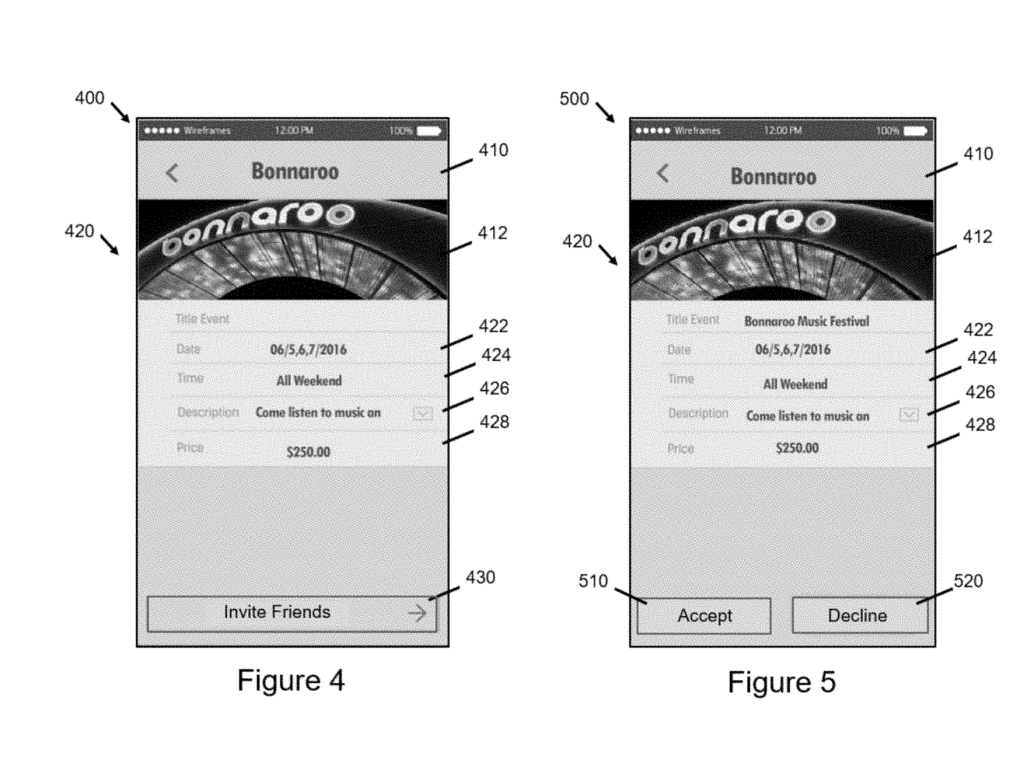

Embodiments of the mobile payment system 100 can enable clients to create an event and invite friends to attend, and then keep track of payments while allowing real time contact through event messaging. A client could use this capability to collect funds for a trip with friends and family, for fantasy sports, for group funded parties, for buying groups of concert, sporting or other event tickets with friends, or other purposes. FIGS. 4-7 illustrate exemplary embodiments of this event functionality.

FIG. 4 illustrates an exemplary event organizer screen 400 that includes an event title field 410, an event information area 420 and an Invite Friends selection 430. The event information area 420 includes an event image field 412, a date field 422, a time field 424, a description field 426 and a price field 428. The organizer, a client of the mobile payment system 100, enters the desired information in the event title field 410 and the event information area 420 and then selects the Invite Friends selection 430. The Invite Friends selection 430 brings up a potential invitee list which includes a list of all the friends of the organizer that are clients of the mobile payment system 100 as determined based on the user profile stored in the mobile payment system database 152. The organizer can filter the potential invitee list and send invites to the desired invitees, including the organizer. The organizer also establishes an event user account 158 controlled by the MPS backend 150 that is used to hold funds to be used for the event.

FIG. 5 illustrates an exemplary event invite screen 500 that includes non-editable versions of the event title field 410, the event image field 412, the event date field 422, the event time field 424, the event description field 426 and the event price field 428. The event invite screen 500 also includes an invite accept selection 510 and an invite decline selection 520. If an invited user selects the invite accept selection 510, then the mobile payment system 100 initiates a funds transfer from the accepting user's user account 134 to the event user account 158, and sends an acceptance notification to the organizer indicating event acceptance by the accepting user. If an invited user selects the invite decline selection 520, then the mobile payment system 100 sends a decline notification to the organizer indicating event decline by the declining user.

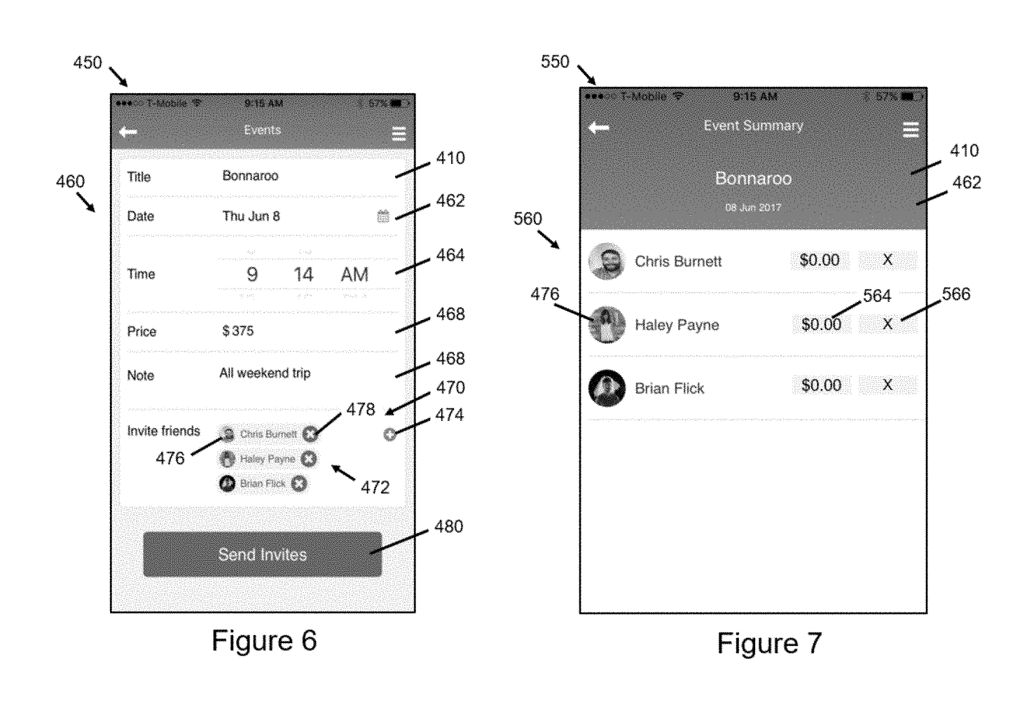

FIG. 6 illustrates another exemplary event organizer screen 450 that includes an event title field 410, an event information area 420, an invitee area 470, and a Send Invites selection 480. The event information area 460 includes a date field 462, a time field 464, a description field 466 and a price field 468. The organizer, a client of the mobile payment system 100, enters the desired information in the event title field 410, and the event information area 460 and selects the people to invite to the event in the invitee area 470. The invitee area 470 includes an invitee list 472, an add invitee selection 474 and for each invitee on the invitee list 472 includes an invitee identifier 476 (for example, an image and/or name), and a remove invitee selection 478. The add invitee selection 474 brings up a list of friends of the organizer that are clients of the mobile payment system 100 as determined based on the user profile stored in the mobile payment system database 152. The organizer can select one or more invitees from this friends list to be included or added to the invitee list 472. The organizer can select the remove invitee selection 478 next to an invitee identifier 476 to remove that person from the invitee list 472. The organizer can filter the invitee list 472 using the add and remove invitee selections 474, 478, and then send invites to the people on the invitee list 472 by selecting the Send Invites selection 480. The MPS can also establish an event user account 158 controlled by the MPS backend 150 that is used to hold funds to be used for the event. Each of the people on the invitee list 472 can receive an invite similar to the one shown in FIG. 5.

FIG. 7 illustrates an exemplary event summary screen 550 that includes a non-editable event title field 410, the event date field 462 and an invitee status list 560. The invitee status list 560 includes, for each invitee on the invitee list 472, the invitee identifier 476, a status indicator 564 and a remove invitee selection 566. If an invited user selects the Invite Accept selection 510, then the mobile payment system 100 can initiate a funds transfer from the accepting user's user account 134 to the event user account 158, update the status indicator 564 for the accepting user, and send an acceptance notification to the organizer indicating event acceptance by the accepting user. Updating the status indicator 564 for the accepting user can include entering the amount paid by the accepting user. If an invited user selects the Invite Decline selection 520, then the mobile payment system 100 can update the status indicator 564 for the declining user and send a decline notification to the organizer indicating event decline by the declining user. Updating the status indicator 564 for the declining user can include entering a decline indicator in the status indicator 564 or removing the declining user from the invitee status list 560. The event summary screen 550 may only be available to the organizer, or the organizer and invitees on the invitee list 472. The ability to use the remove invitee selection 566 may only be available to the organizer.

The payment system can enable private or one-time payments that enable clients to send private payments to those with whom they have no social or digital relationship, and also to send payments to non-client individuals before they sign up for the mobile payment system 100. For example, a client may want to pay a repairman or contractor at their home, or purchase a car or flea market item from a vendor. The client can send and receive P2P payments privately and securely through the mobile payment system 100 without having to befriend or give out personal information to the other party. The one-time payment feature can enable a client to pay a recipient via the recipient's phone number whether or not the recipient has an account on the mobile payment system 100. This can be done by tying the payment to the phone number or email address of the recipient, and sending the recipient a text or email notification to confirm the money is waiting. The message confirming payment to the recipient can include an invitation to the payee to download the mobile payment system frontend 114 to an electronic device to retrieve the payment and redirect the funds with or without opening an account on the mobile payment system 100. The message confirming payment to the recipient can also include instructions on how to enter their financial account information to retrieve the payment and redirect the funds to their financial account without opening an account on the mobile payment system 100. The message confirming payment to the recipient can also include a link to enter their account on the mobile payment system 100 to transfer the payment to their MPS user account 158 or a third-party user account 134 tied to their MPS account 158, without revealing personal information between the sender and recipient.

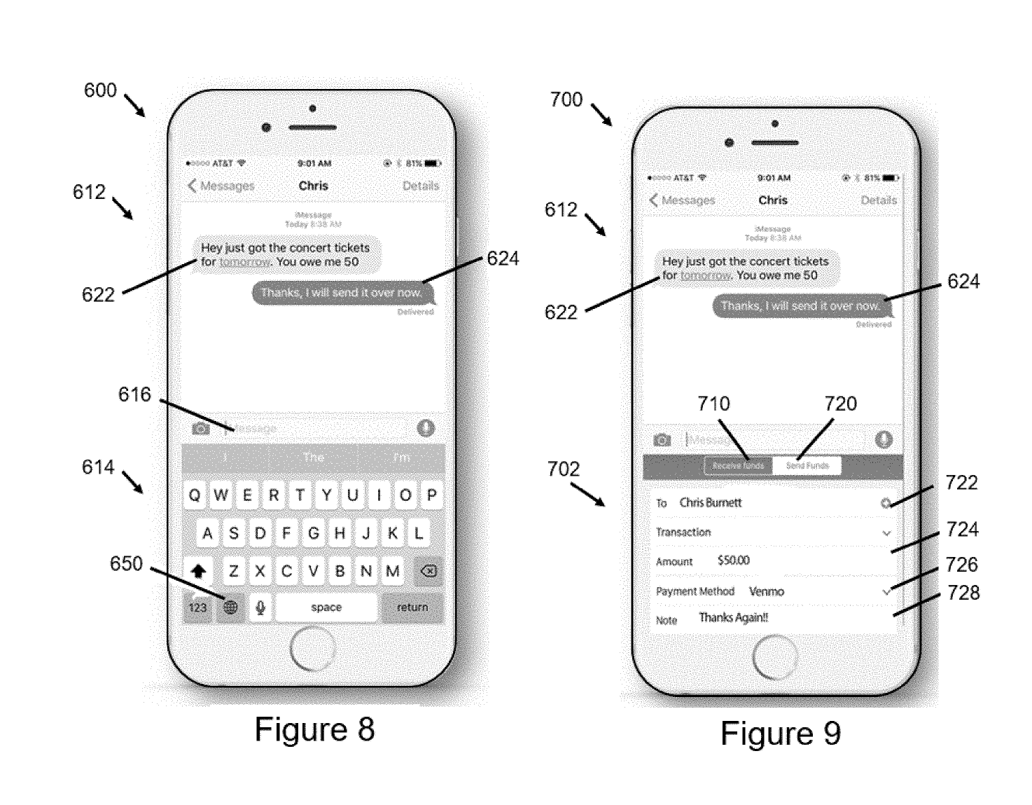

The mobile payment system 100 can support a keyboard extension that allows clients to send and receive P2P payments with text messages without having to leave the text messaging feature of their electronic or mobile device 110. This feature of the mobile payment system 100 can enable users to send and receive money via text messaging through any device feature that uses and allows keyboard extensions, for example: Facebook Messenger, Instagram, Twitter, Skype, Tumblr, email messages, and others. For example, while two users of the mobile payment system 100 are sending messages back and forth, one user can request a payment from the other user using the keyboard extension, or one user can send money to another user or non-user using the keyboard extension. An example of this feature is shown in FIGS. 8 and 9.

FIG. 8 illustrates an exemplary messaging display 600 on a user device 110. The messaging display 600 includes a text display area 612, a virtual keyboard 614 and a text entry area 616. A user can use the keyboard 614 to type a new message in the text entry area 616, and when the user has finished typing the new message in the text entry area 616, the user can hit a send button to send the new message. The conversation which includes received messages 622 from another user and sent messages 624 from the user of the user device 110. The keyboard 614 also includes a payment system key 650 that brings up a mobile payment system (MPS) transaction area 702.

FIG. 9 illustrates an exemplary transfer funds screen 700 on the user device 110 in the text messaging application with the text display area 612 and the MPS transaction area 702 displayed. The MPS transaction area 702 includes a receive funds selection 710 and a send funds selection 720. A sending payee client can select the receive funds selection 710 to bring up fields for sending an invoice message to a receiving payer client of the mobile payment system 100, that will enable the payer client to simply approve the invoice message to transfer funds from the payer client's MPS user account 158 (or a third-party user account 134 tied to their MPS user account 158) to the sending payee client's MPS user account 158 (or a third-party user account 134 tied to their MPS user account 158). A sending payer client can select the send funds selection 720 to bring up fields for sending a payment message to a receiving payee client of the mobile payment system 100, that will enable the receiving payee client to simply approve the payment message to transfer funds from the sending payer client's MPS user account 158 (or a third-party user account 134 tied to their MPS user account 158) to the receiving payee client's MPS user account 158 (or a third-party user account 134 tied to their MPS user account 158). The mobile payment system 100 can also send transfer confirmation messages to the payee and payer clients when the transfer is complete.

FIG. 9 illustrates an example of the MPS transaction area 702 when a sending client has selected the send funds selection 720. In this case, the MPS transaction area 702 includes a payee recipient field 722, a transaction amount field 724, a payment method field 726 and a note field 728. The sending client information for this transaction automatically defaults to the user profile information associated with the electronic device 110 of the sending client that brought up the MPS transaction area 702. The entry in the payee recipient field 722 can default to the person in the current text messaging conversation and can enable the sending client to type in or bring up a selectable list of other clients of the mobile payment system 100 that the sending client has a connection with through the mobile payment system 100. The sending client enters a payment amount in the amount field 724. The sending client enters a payment method in the payment method field 726 or the mobile payment system frontend 114 provides a drop down menu of available payment methods for the sending client to choose between. The payment methods available to a sending client will only include MPS user accounts 158, third party user accounts 134 and/or bank accounts that the sending client has associated with their MPS user account 158 through their profile stored in the mobile payment system database 152. The sending client can enter a message in the note field 728. When the sending client has entered the information in the fields of the MPS transaction area 702 and is satisfied with the information, the sending client can select a send or enter selection, for example the send funds selection 720, and a payment message is sent from the mobile payment system frontend 114 on the sending user's electronic device to the mobile payment system backend 150.

The mobile payment system backend 150 can retrieve the sending and recipient client information from the MPS database 152 using the phone numbers of the sending client and the person listed in the payee recipient field 722. The mobile payment system backend 150 can confirm that the sending client has the available funds listed in the amount field 724 in their user account listed in the payment method field 726. When the identities of the sending and receiving clients are confirmed, and the funds are confirmed, the mobile payment system backend 150 can send a payment message to the receiving client listed in the payee recipient field 722. The payment message received by the receiving payee client includes fields similar to those shown in the MPS transaction area 702 except that the payee recipient field 722 is replaced by a sending payer field listing the sending client name, the transaction amount field 724 is not editable, and the note field 728 is not editable. The payment method field 726 is replaced by a receiving method field that provides a drop down list of available MPS user accounts 158, third party user accounts 134 and/or bank accounts that the receiving client has associated with their MPS user account 158 through their profile stored in the mobile payment system database 152. The receiving method field can have a default user account listed which the receiving client can change using the drop down list. When the receiving user approves the payment message the mobile payment system 100 transfers the funds in the amount listed in the amount field 724 from the sending client user account listed in the payment method field 726 to the receiving client user account listed in the receiving method field. The receiving user can approve the payment method by various confirmation methods, for example, by selecting an accept option in the payment message and entering a personal identification number (PIN) or a thumbprint. The sending and receiving users will each receive a text message confirmation when the funds transfer is complete and a receipt/record in their mobile payment system 100 transaction record showing the transaction, for example as shown in FIG. 3. Also when the Send Funds button 720 is selected, the MPS transaction area 702 can close and the regular keyboard 614 can come back up as shown in FIG. 8.

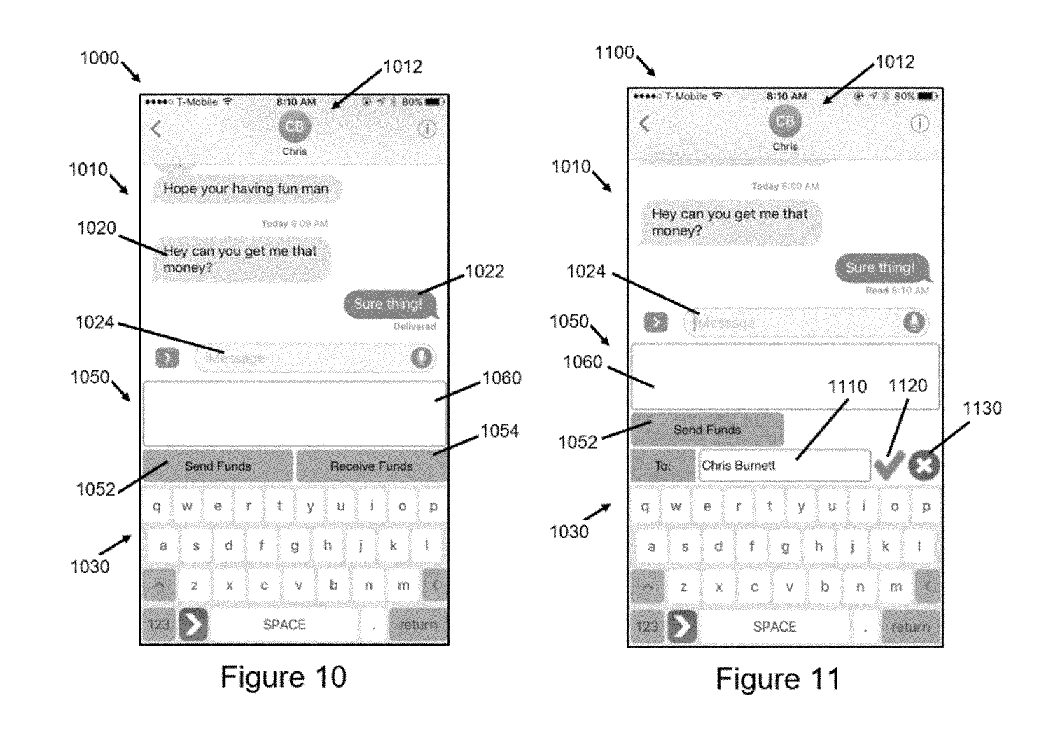

FIG. 10 illustrates an alternative exemplary embodiment of a user device in a text messaging application on a transfer funds screen 1000 with a text display area 1010, a virtual keyboard 1030 and an alternative exemplary embodiment of an MPS transaction area 1050 displayed. The text display area 1010 includes a correspondent identifier 1012, a text entry field 1024, and a conversation which includes received messages 1020 from the correspondent user and sent messages 1022 from the user of the user device 110. The MPS transaction area 1050 when initially brought up includes a Send Funds selection 1052, a Receive Funds selection 1054 and a transfer memo field 1060 where the device user can enter a note or memo regarding the current funds transfer. The user can select the Send Funds selection 1052 to initiate a transfer from the user, or select the Receive Funds selection 1054 to initiate an invoice to another user to receive funds from another user. The virtual keyboard 1030 can be used at this point to enter characters into the text entry field 1024 to continue sending text messages in the conversation with the user identified by the correspondent identifier 1012. When the transfer memo field 1060 is selected, the virtual keyboard 1030 can be used to enter characters into the transfer memo field 1060 to record a memo regarding the funds transfer.

Selecting the Send Funds selection 1052 brings up a send funds screen 1100 shown in FIG. 11 which includes the text display area 1010, the virtual keyboard 1030 and the MPS transaction area 1050. The text display area 1010 includes the correspondent identifier 1012, the text entry field 1024 and the conversation. After selection of the Send Funds selection 1052, the MPS transaction area 1050 includes the Send Funds selection 1052, a transfer recipient field 1110, an accept recipient selection 1120 and a go back selection 1130. The transfer recipient field 1110 can automatically default to the user identified in the correspondent identifier 1012 with whom the device user is currently text messaging. The device user can select the transfer recipient field 1110 and use the virtual keyboard 1030 to change the user in the transfer recipient field 1110. Selecting the accept recipient selection 1120 indicates that the device user wants to send the funds to the user currently identified in the transfer recipient field 1110. Selecting the go back selection 1130 indicates that the device user wants to exit the send funds screen 1100 and go back to the transfer funds screen 1000. The virtual keyboard 1030 can be used at this point to enter characters into the text entry field 1024 to continue sending text messages to the user identified by the correspondent identifier 1012. When the transfer memo field 1060 is selected, the virtual keyboard 1030 can also be used to enter characters into the transfer memo field 1060 to record a memo regarding the funds transfer.

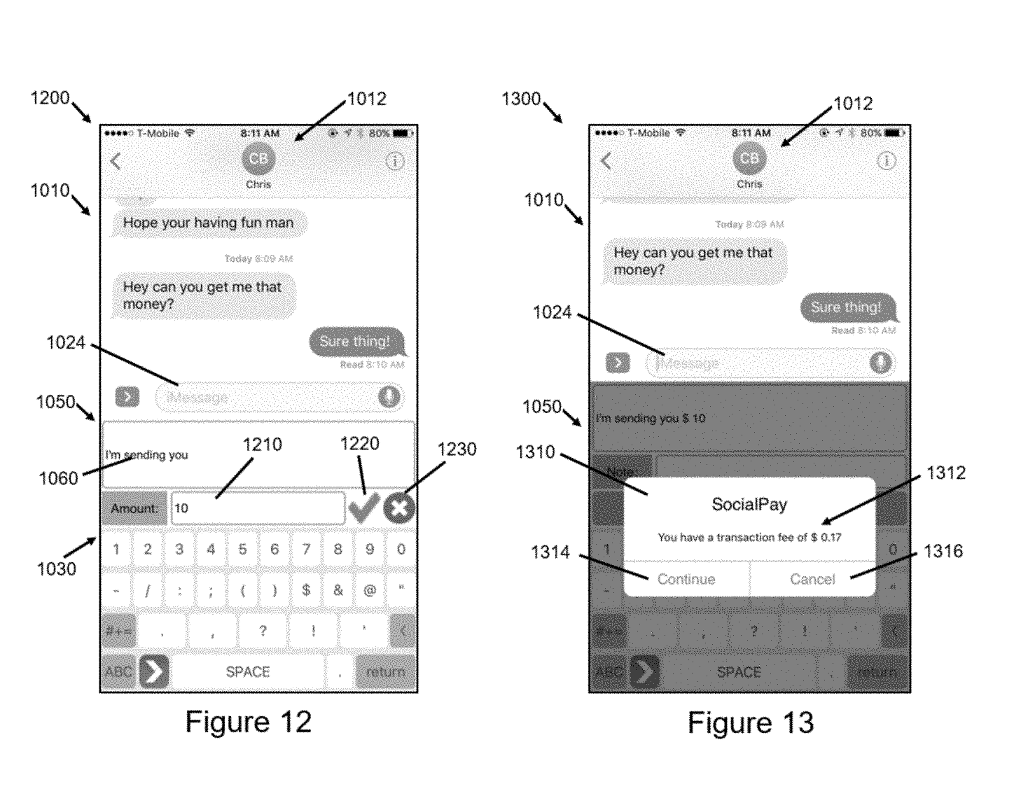

Selecting the accept recipient selection 1120 on the send funds screen 1100 (FIG. 11) brings up an amount entry screen 1200 shown in FIG. 12 which includes the text display area 1010, the virtual keyboard 1030 and the MPS transaction area 1050. The text display area 1010 includes the correspondent identifier 1012, the text entry field 1024 and the conversation. After selection of the accept recipient selection 1120, the MPS transaction area 1050 includes an amount entry field 1210, an accept amount selection 1220 and a go back selection 1230. The device user can select the amount entry field 1210 and use the virtual keyboard 1030 to enter an amount in the amount entry field 1210. Selecting the accept amount selection 1220 indicates that the device user wants to send the amount of funds currently shown in the amount entry field 1210 to the user previously identified in the transfer recipient field 1110. Selecting the go back selection 1230 indicates that the device user wants to exit the amount entry screen 1200 and go back to the send funds screen 1100. The virtual keyboard 1030 can be used at this point to enter characters into the text entry field 1024 to continue sending text messages to the user identified by the correspondent identifier 1012. When the transfer memo field 1060 is selected, the virtual keyboard 1030 can also be used to enter characters into the transfer memo field 1060 to record a memo regarding the funds transfer as shown in FIG. 12. The transfer funds functionality of the MPS system 100 can enable selection of a payment method or account (shown by the examples in FIGS. 2 and 9) which can automatically start at a default value. Alternatively, the user can select a default payment method or account for their transactions in a settings menu and the MPS functions will use this default account until another is selected (shown by the examples in FIGS. 10-14).

Selecting the accept amount selection 1220 on the amount entry screen 1200 (FIG. 12) brings up a transaction fee acceptance screen 1300 shown in FIG. 13 which includes the text display area 1010 and the MPS transaction area 1050. The text display area 1010 includes the correspondent identifier 1012, the text entry field 1024 and the conversation. After selection of the accept amount selection 1220, the MPS system 100 can display a transaction fee acceptance window 1310 which includes a message 1312, a continue selection 1314 and a cancel selection 1316. The message 1312 in this case informs the device user of a transaction fee for the transaction that the device user is currently requesting. Similar transaction fee windows 1310 can come up in other instances while using the MPS system 100. Selecting the continue selection 1314 indicates that the device user accepts and agrees to pay the displayed transaction fee, and wants to continue with the current transaction. Selecting the cancel selection 1316 indicates that the device user does not accept the displayed transaction fee, and wants to return to the amount entry screen 1200. The virtual keyboard 1030 can be blocked by the transaction fee window 1310 to cause the device user to respond with one of the transaction fee window selections 1314, 1316 before proceeding.

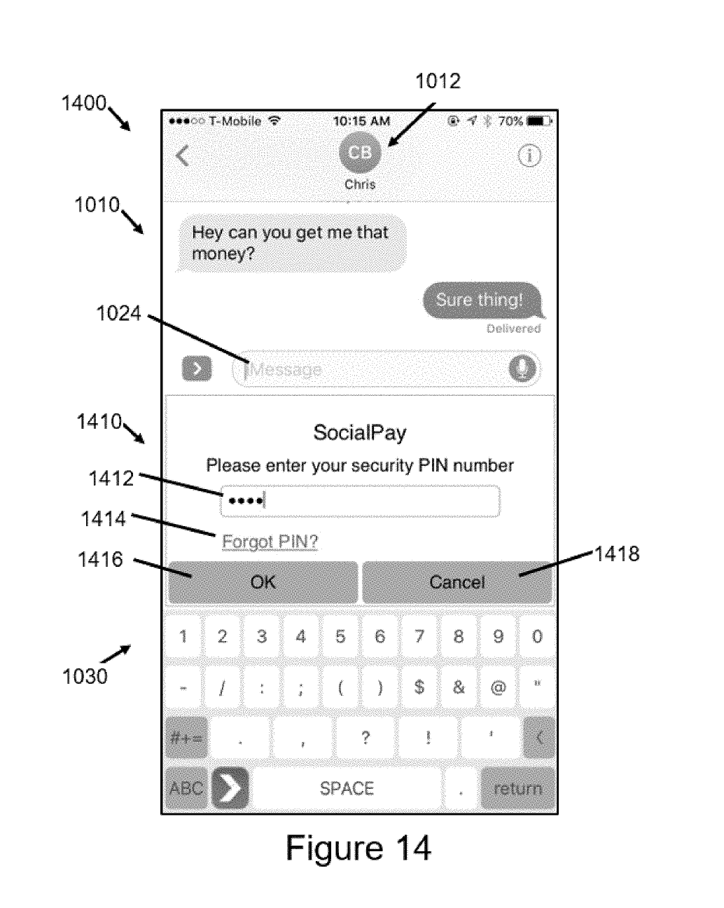

Selecting the continue selection 1314 on the transaction fee window 1310 (FIG. 13) brings up a user authentication screen 1400 shown in FIG. 14 which includes the text display area 1010, a user authentication area 1410 and the virtual keyboard 1030. In this example, the MPS system 100 uses a personal identification number (PIN) to authenticate the user but alternatively passwords, biometric data or other authentication methods can be used. This user authentication area 1410 includes a PIN entry field 1412, a Forgot PIN selection 1414, an OK selection 1416 and a Cancel selection 1418. The user can use the virtual keyboard 1030 to enter characters of their PIN in the PIN entry field 1412. Selecting the Forgot PIN selection 1414 brings the user to an alternative authentication process where they can enter other authentication information and/or establish a new PIN to continue the current transaction. After the user has finished entering their PIN in the PIN entry field 1412, they can select the OK selection 1416. After the user selects the OK selection 1416, if the MPS system 100 confirms the PIN in the PIN entry field 1412 is correct, then the MPS system 100 executes the transaction as described elsewhere. After the user selects the OK selection 1416, if the MPS system 100 finds the PIN in the PIN entry field 1412 is incorrect, then the MPS system can allow the user to reenter a PIN in the PIN entry field 1412, or challenge the user with other authentication methods, or cancel the transaction, or take other appropriate actions. Selecting the Cancel selection 1418 indicates that the device user does not want to follow through with the current transaction, and wants to return to the amount entry screen 1200.

When funds are being transferred between a sender's user account 134/158, a recipient's user account 134/158 and a MPS account 132, there can be several backend transactions that need to occur to move the money between the right accounts so the funds are available in the right places.

Payments primarily flow into a MPS account 132 on a sender's payment network 130S (sending system MPS account 132S), and out of a second MPS account 132 on a recipient's payment network 130R (receiving system MPS account 132R). Upon request or periodically, funds can be moved out of a sending system MPS account 132S on a payment network 130S into a mobile payment system bank account 154 or credit card, and into a receiving system MPS account 132R on another payment network 130R to fund future payments on the various payment networks. This can be done automatically through a series of automated processes.

The mobile payment system 100 can have a primary bank account (e.g., the MPS bank account 154) and a plurality of active system accounts (e.g, the MPS accounts 132). The active system accounts can include the sending system MPS accounts 132S and receiving system MPS accounts 132R used to support user transactions. Active system accounts can be present on each of the third party payment networks 130 with a mobile payment system client. Obviously one MPS account 132 on a payment network 130 can function as both the sending system account 132S and the receiving system account 132R for all of the mobile payment system clients on that network 130. The mobile payment system 100 can have a desired funding level for each of the MPS accounts 132. These MPS accounts 132 can be reconciled periodically or as desired. The MPS accounts 132 can also have refunding and defunding thresholds. When the balance in a MPS account 132 falls below the refunding threshold, funds can automatically be transferred from the MPS bank account 154 or a credit card to that MPS account 132 to restore that MPS account 132 to the desired funding level. When the balance in a MPS account 132 rises above the defunding threshold, funds can automatically be transferred from that MPS account 132 to the MPS bank account 154 to restore that MPS account 132 to the desired funding level.

An example of a process the MPS backend 150 can use to reconcile the various MPS accounts 132 is as follows. User transactions transferring funds between a sending payment network 130S and a receiving payment network 130R result in funds being deposited into the MPS account 132S of the sending payment network 130S. The MPS backend 150 can request fund withdrawals from the MPS accounts 132S on the sending payment networks 130S into the MPS bank account 154. The MPS backend 150 can create a log of the transactions included in the deposit from each MPS account 132S to the MPS bank account 154. The transaction log for each transaction can include, for example: a transaction identifier, a transaction date, a transaction time, a sending network 130S, a sender identifier, a sender name, an amount to send to recipient, an amount to send to the MPS account 132S, a recipient network 130R, a recipient identifier, a recipient name, a status, etc. The transactions can be grouped and totaled by recipient payment network 130R so that the MPS backend 150 will know how much to transfer to each payment network to cover payments to recipients. The MPS backend 150 can initiate a daily payment transaction from the MPS bank account 154 to each recipient payment network MPS account 132R in the amount of that day's total payments due to that recipient payment network 130R. Once the daily payment is made from the MPS bank account 154 to the MPS account 132R on the recipient payment network 130R, the MPS backend 150 can assign payments to the individual user transactions in the MPS backend 150. The MPS backend 150 can take a grouped payment (e.g., $100) and apply payments to the pending individual user transactions (e.g., $15, $25, $30, $20 and $10 respectively). The MPS backend 150 can update the status of the recipient user payment transactions (e.g., from “PrePaid” to “Paid” or some other terms) to indicate that the payment from the MPS account 132R was covered by and reconciled with an actual client payment. This means that the transaction that was paid in advance from the MPS account 132R was now reconciled with a corresponding reimbursement from a client payment to the MPS account 132S which has now flowed through the MPS bank account 154. This can enable the MPS backend 150 to make sure at a detail level that each and every outgoing recipient payment transaction is covered by an incoming sender payment transaction, which ensures every transaction is being covered and can quickly and easily uncover any issues. The MPS backend 150 can produce a log that shows that all of the prepaid transactions have been covered. This can be useful in auditing individual transactions or pinpointing discrepancies or items that are not paid. It should be noted that this reconciling process is an internal exercise. The recipient client payment has been made from the MPS account 132R on the recipient payment network 130R ahead of time. This process is refilling the MPS account 132R on the recipient payment network 130R so that all prepayments are covered by actual client payments into MPS accounts 132S on sending payment networks 130S. The assigning of payments can be arbitrary based on oldest item paid first. If the MPS backend 150 is tracking a transaction identifier, it can track the status of the whole transaction from sender to recipient whether it is pending or paid. Using the same common transaction identifier enables the MPS backend 150 to track the status of the backend financial payment, that is, that a $15 payment sent by Sender A on sender payment network 130S to Recipient B on recipient payment network 130R was covered by a funds transfer from the MPS bank account 154 to the recipient payment network MPS account 132R. Each day several reports can be generated for monitoring and auditing purposes, for example, a report of funds collected in each sending payment network MPS account 132S, a report of withdrawals from each sending payment network MPS account 132S to the MPS bank account 154, a report of payments required from each recipient payment network MPS account 132R, etc. The reconciliation process can help ensure smooth handling of payment transactions from sender to MPS accounts to recipient.

To integrate the mobile payment system backend with client environments like the mobile payment system mobile user interface and messaging environments, the mobile payment system can include interfaces to effectively exchange data with client systems. These interfaces can include functionality to accomplish the various functions of authenticating, identifying users and accounts, sending funds, receiving funds, posting notifications etc.

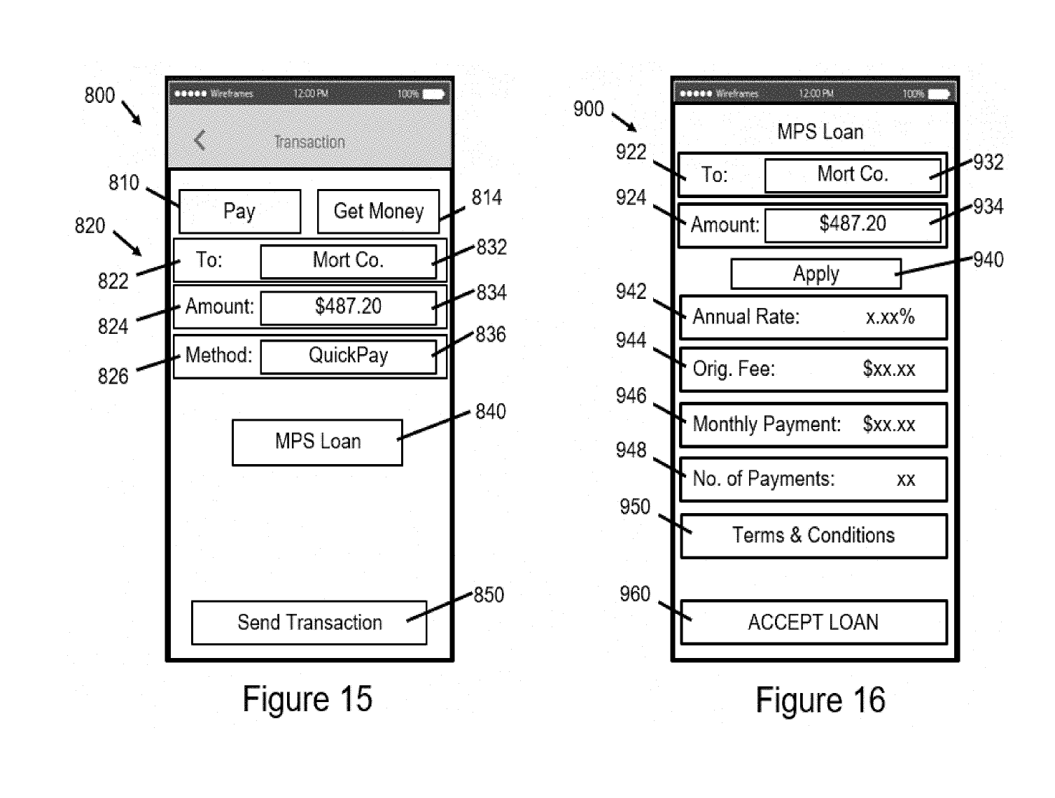

FIG. 15 illustrates an alternative example of a transaction interface 800 brought up by a MPS frontend 114 on an electronic device 110 of a user of the mobile payment system 100 for a sender client (payer) sending money to a recipient (payee). The payee can be a person or some other type of entity, for example a credit card payee, rent payee, mortgage company, insurance company, etc. The transaction interface 800 includes a pay funds selection 810, a get funds selection 814, a transaction details section 820 and a send transaction selection 850. A client user can use the pay funds selection 810 when the client user wants to transfer funds to another person or entity. A client user can use the get funds selection 814 when the client user wants to send a request to another user to transfer funds to the client user.

In the case shown in FIG. 15, the pay funds selection 810 is selected which displays the following fields in the transaction details section 820: a recipient field 822, an amount field 824 and a payment method field 826. The sender client information for this transaction automatically defaults to the user profile information associated with the electronic device 110 of the sender client that brought up the transaction interface 800. The sender client can enter a recipient name in the recipient field 822. The recipient field 822 can include a recipient selection 832 (for example, a drop down menu, pop up window, etc.) that provides previously entered recipients for the sender client. The sender client can select a recipient from the recipient selection 832 to populate the recipient field 822. The mobile payment system frontend 114 can also list potential matches in the recipient field 822 as the sender types in the recipient name. If no client match is found for the name entered in the recipient field 822, the mobile payment system frontend 114 can list alternatives for selection by the sender client, or provide a warning that no matching recipient was found. The sender client enters a payment amount in the amount field 824. The amount field 824 can include a default amount selection 834 that provides previously entered or set-up amount for the sender client for the recipient selected in the recipient field 822. For example, the expected monthly amount for a rent, mortgage, mobile phone or other payment may remain generally constant and this expected amount can be set up by the sender client to automatically appear in the default amount selection 834 when the associated recipient is selected in the recipient selection 832. The sender client can overwrite a default amount automatically appearing in the default amount selection 834. The sender client enters a payment method in the payment method field 826. The payment method field 826 can include a payment method selection 836 (for example, a drop down menu, pop up window, etc.) that provides available payment methods for the sender client to choose between. The available payment methods in the payment method selection 836 can include payment network accounts or bank accounts that the sender client has associated with their mobile payment system account through their profile stored in the mobile payment system database 152. The sender client can select a payment method from the payment method selection 836 to populate the payment method field 826. When all of the fields in the transaction details section 820 have been properly filled-in, the sender client can select the send transaction selection 850 to send the currently entered transaction to the MPS backend 150 for execution by the MPS system 100.

When the pay funds selection 810 is selected, the transaction interface 800 brought up by the MPS frontend 114 can also display a MPS loan selection 840. The MPS loan selection 840 can be displayed for all or selected payment transactions depending on the sender client, the selected recipient and other parameters. When the sender client selects the MPS loan selection 840, a loan application window 900 can be displayed. FIG. 16 illustrates an example of a loan application window 900. This MPS loan applied for in the loan application window 900 can be directly with the MPS system 100 or with a third party through the MPS system 100. The loan enables a MPS client to make a timely mortgage payment, insurance payment, rental payment, auto payment, utility bill payment, or other type of payment and avoid late fees, penalties or other charges or hassles from the creditor. The avoidance of creditor fees and possible credit rating impacts can make a loan from/through the MPS system worth a facilitation or origination charge. Unlike pay day advance services, the MPS client will never touch the loan funds, as they will be paid directly from the MPS system 100 to the lender or service provider recipient specified by the sender client. This avoids possible diversion of the funds by the sender client to other nondisclosed or recreational uses which greatly reduces the risk profile for the MPS loan.

The loan application window 900 includes a recipient field 922 and an amount field 924 that can automatically be populated with the information from the recipient field 822 and amount field 824 of the transaction details section 820. The sender client can also change the contents of the recipient field 922 and the amount field 924. The recipient field 922 can include a recipient selection 932 and the amount field 924 can include a default amount selection 934 with similar selection methods to those described above for the recipient selection 832 and amount selection 834 of the transaction details section 820. When the desired information is entered in the recipient field 922 and amount field 924, the sender client can select an apply selection 940.

When the apply selection 940 is selected, the information in the recipient field 922 and the amount field 924 along with an identifier for the sender client is sent to the MPS backend 150 where loan processing occurs. This loan processing can use the profile information for the sender client along with other information regarding the sender client, the recipient and other parameters to compute loan details. Loan processing can have a short turnaround, for example 30 seconds, or may require personal attention. If the loan processing for a particular loan request is expected to take more than a response threshold, the MPS backend 150 can send a message to the MPS frontend 114 on the electronic device 110 of the sender client that a loan response message will be sent to the sender client when loan processing is complete. When the loan processing for a particular loan request is complete or if the loan response message offers a loan for the loan request, then loan information populates the loan application window 900.

The exemplary loan application window 900 of FIG. 16 shows loan information that includes an annual rate field 942, an origination fee field 944, a monthly payment field 946, a number of payments field 948, a terms selection 950 and an accept selection 960. The annual rate field 942 provides an annual percentage rate for the loan offer. The origination fee field 944 shows the origination fee, if any, to be paid by the sender client if the loan offer is accepted. The monthly payment field 946 shows the monthly payment to be paid by the sender client if the loan offer is accepted. The number of payments field 948 shows the number of monthly payments of the amount in the monthly payment field 946 to be paid by the sender client if the loan offer is accepted. The terms selection 950 provides the additional terms and conditions associated with the loan offer to the sender client. The sender client can accept the loan under the displayed and disclosed terms by selecting the accept selection 960. If the accept selection 960 is selected by the sender client, an acceptance message is sent to the MPS backend 150 where the requested funds in the amount field 924 is sent from a MPS account 132, 154 to an account of the recipient identified in the recipient field 922. At the same time, any origination fee displayed in the origination fee field 944 is transferred from the MPS user account 158 for the sender client to a MPS account 132, 154. A monthly recurring payment of the amount shown in the monthly payment field 946 for the number of times shown in the number of payments field 948 can be set up in the MPS backend 150 to transfer funds from the MPS user account 158 for the sender client to a MPS account 132, 154. Alternatively, a payment method option can be included in the loan application window 900 for the origination fee or any other sender client payments, and the amounts of such payments can be collected by the MPS system 100 from the identified payment method.

Some commercial lenders and/or service providers may even “buy down” the consumers' costs for the sender client as the MPS loan enables them to avoid the very real costs of paperwork and human time to notify and resolve late payment or nonpayment issues, and also can protect the credit rating and resale value in a package of loans or mortgages. The mortgage holders, insurance companies and other lenders and service providers can maintain a perfect customer payment record. These “buy down” amounts can be collected by the MPS system 100 when a sender client accepts a MPS loan for a payment to the associated commercial lender or service provider. In addition, the MPS client will also have a clean credit report regarding the otherwise late or missed payment. A state regulated and approved lender can be used to provide these loan services, and the MPS system 100 can simply add a facilitation fee for providing the loan option.

While the disclosure has been illustrated and described in detail in the drawings and foregoing description, such illustration and description is to be considered as exemplary and not restrictive in character, it being understood that illustrative embodiment(s) have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention.

We claim:

1. A mobile payment system (MPS) method that enables transactions for a plurality of MPS users using a plurality of user electronic devices, the mobile payment system method comprising:
installing a MPS frontend on each of the plurality of user electronic devices, each MPS frontend performing local processing of MPS functions on the user electronic device on which that MPS frontend is installed;
associating each of the MPS frontends with one of the MPS users and with one of the plurality of user electronic devices;
interfacing with a plurality of third party payment systems that each have a plurality of third party user accounts;
establishing a third party MPS account on each of the third party payment systems;
creating a MPS backend comprising a MPS backend account, a MPS database and a plurality of MPS user accounts, each of the plurality of MPS user accounts being associated with at least one of the MPS users;
communicating over networks between the MPS backend and each of the MPS frontends and each of the third party payment systems, and communicating over the networks between each of the MPS frontends;
transferring funds between the MPS user accounts and third party user accounts as directed by the plurality of MPS users; and
controlling the transfer of funds between the MPS backend account, the plurality of third party MPS accounts, the MPS user accounts and third party user accounts.

2. The mobile payment system method of claim 1, further comprising:
associating each of the plurality of MPS user accounts with at least one of the third party user accounts on the third party payment systems.

3. The mobile payment system method of claim 2, further comprising:
establishing a new MPS user by:
enabling the new MPS user to download a MPS frontend to a user electronic device associated with the new MPS user;
accepting user profile information from the new MPS user through the MPS frontend, the user profile information including user identification information, user contact information, and a user phone number associated with the user electronic device associated with the new MPS user;
sending the user profile information from the MPS frontend to the MPS backend;
storing the user profile information in the MPS database;
if the new MPS user provides a third party user account, establishing a new MPS user account and associating the new MPS user account with the third party user account provided by the new MPS user;
if the new MPS user does not provide a third party user account, walking the new MPS user through establishing a new third party user account;
establishing a new MPS user account and associating the new MPS user account with the new third party user account of the new MPS user;
generating user authentication data associated with the new MPS user.

4. The mobile payment system method of claim 3, wherein the user authentication data is based on the user phone number associated with the user electronic device associated with the new MPS user.

5. The mobile payment system method of claim 2, wherein the MPS functions include a transfer funds function for transferring funds from a sender MPS user to a recipient, the transfer funds function comprising:
displaying a transaction interface on the MPS frontend associated with the sender MPS user;
enabling the sender MPS user to enter a recipient identifier, a transfer amount and a payment method into the transaction interface;
enabling the sender MPS user to submit the transfer request by sending the recipient identifier, the transfer amount and the payment method from the MPS frontend associated with the sender MPS user to the MPS backend;
confirming a sender account associated with the sender MPS user has sufficient funds for transfer of the transfer amount from the sender account;
if the sender account has sufficient funds, then:
determining the recipient from the recipient identifier;
transferring the transfer amount from the sender account;
transferring the transfer amount to a recipient account associated with the recipient;
sending a sender confirmation message to the sender MPS user; and
sending a recipient confirmation message to the recipient;
if the sender account does not have sufficient funds, sending a cancel notice to the sender MPS user.

6. The mobile payment system method of claim 5, wherein the recipient identifier is a recipient phone number, and if the sender account has sufficient funds, then:
determining the recipient from the recipient identifier;
sending a new transfer message using the recipient phone number, the new transfer message including instructions on how to retrieve the transfer amount;
waiting for a response to the new transfer message; and
determining the recipient account based on the response to the new transfer message.

7. The mobile payment system method of claim 6, wherein the new transfer message includes instructions on how to open a new MPS user account and instructions on how to transfer the transfer amount to an existing MPS user account or third party user account, and wherein transferring the transfer amount to a recipient account comprises:
if the response to the new transfer message is to open a new MPS user account, then determining the recipient account based on the response to the new transfer message comprises:
downloading a MPS frontend to an electronic device associated with the recipient;
accepting user profile information from the recipient through the MPS frontend;
storing the user profile information in the MPS database;
opening a recipient MPS user account associated with the recipient; and
transferring the transfer amount to the recipient MPS user account;
if the response to the new transfer message is to transfer the transfer amount to an existing MPS user account, then determining the recipient account based on the response to the new transfer message comprises:
accepting an MPS user identifier and recipient user authentication information for the existing MPS user account;
confirming the recipient user authentication information matches stored user authentication information for the existing MPS user account; and
if the recipient user authentication information matches, then transferring the transfer amount to the existing MPS user account; and
if the response to the new transfer message is to transfer the transfer amount to a third party user account, then determining the recipient account based on the response to the new transfer message comprises:
accepting a third party user account identifier; and
attempting to transfer the transfer amount to a third party user account associated with the third party user account identifier.

8. The mobile payment system method of claim 5, wherein the recipient identifier identifies a recipient associated with a recipient MPS user account of the plurality of MPS user accounts, and if the sender account has sufficient funds:
transferring the transfer amount to a recipient account comprises transferring the transfer amount into the recipient MPS user account; and
sending a recipient confirmation message comprises sending the recipient confirmation message to a user phone number associated with the recipient MPS user account.

9. The mobile payment system method of claim 5, wherein the payment method is associated with a sender third party payment system of the plurality of third party payment systems, and wherein:
confirming a sender account associated with the sender MPS user has sufficient funds comprises:
determining a sender third party user account on the sender third party payment system that is associated with the sender MPS account;
confirming that the sender third party user account has sufficient funds for transfer of the transfer amount from the sender third party user account;
if the sender third party user account has sufficient funds, then transferring the transfer amount from the sender account comprises:
requesting a first transfer of the transfer amount from the sender third party user account to a sender third party MPS account, the sender third party MPS account being on the sender third party payment system and being one of the plurality of third party MPS accounts; and
not transferring the transfer amount to the recipient account until after the first transfer is confirmed.

10. The mobile payment system method of claim 5, further comprising:
determining a transaction fee for the transfer request;
confirming the sender account has sufficient funds for transfer out of both the transfer amount and the transaction fee;
if the sender account has sufficient funds for transfer out of both the transfer amount and the transaction fee, then:
before transferring any funds or sending any confirmation messages, asking the sender MPS user for acceptance of the transaction fee;
if the sender MPS user does not accept the transaction fee, sending a cancel notice to the sender MPS user;
if the sender MPS user accepts the transaction fee, proceeding with transferring funds and sending confirmation messages.

11. The mobile payment system method of claim 5, further comprising:
before transferring any funds or sending any confirmation messages, requesting entry of sender authentication information from the sender MPS user;
comparing the entered sender authentication information with stored authentication information associated with the sender MPS user account;
if the entered sender authentication information matches the stored authentication information associated with the sender MPS user account, proceeding with the transaction request; and
if the entered sender authentication information does not match the stored authentication information associated with the sender MPS user account, not proceeding with the transaction request.

12. The mobile payment system method of claim 2, wherein the MPS functions include a transfer request for transferring funds from a sender MPS user to a recipient MPS user of the plurality of MPS users, the transfer funds function comprising:
displaying a transaction interface on the MPS frontend associated with the sender MPS user;
enabling the sender MPS user to enter a recipient identifier, a transfer amount and a sender payment method into the transaction interface, the recipient identifier being associated with the recipient MPS user;
enabling the sender MPS user to submit the transfer request by sending the recipient identifier, the transfer amount and the sender payment method from the MPS frontend associated with the sender MPS user to the MPS backend;
determining a sender user account on the sender payment system identified by the sender payment method, the sender user account being one of a sender MPS account associated with the sender MPS user when the sender payment method identifies the MPS system or a sender third party user account associated with the sender MPS user account where the sender payment method identifies the third party payment system,
confirming the sender user account has sufficient funds for transfer of the transfer amount from the sender user account;
if the sender account has sufficient funds, then:
sending a payment request to the MPS frontend associated with the recipient MPS user;
enabling the recipient MPS user to enter a recipient payment method into the payment request;
enabling the recipient MPS user to submit a response to the payment request with the recipient payment method;
determining a recipient user account identified by the recipient payment method, the recipient user account being one of a recipient MPS account associated with the recipient MPS user when the recipient payment method identifies the MPS system, or a recipient third party user account associated with the recipient MPS user account where the recipient payment method identifies a third party payment system;
if the sender account has sufficient funds and the recipient MPS user submits the response to the payment request, then:
transferring the transfer amount from the sender user account;
transferring the transfer amount to the recipient user account;
sending a sender confirmation message to the sender MPS user; and
sending a recipient confirmation message to the recipient MPS user;
if the sender account does not have sufficient funds or the recipient MPS user does not submit the response to the payment request, sending a cancel notice to the sender MPS user.

13. The mobile payment system method of claim 12, wherein when the sender user account is a sender third party user account on a sender third party payment system identified by the sender payment method, and the recipient user account is a recipient third party user account on a recipient third party payment system identified by the recipient payment method, the sender third party payment system being different from the recipient third party payment system, the steps of transferring the transfer amount from the sender user account and transferring the transfer amount to the recipient user account comprise:
initiating a first transfer of the transfer amount from the sender user account to a sender third party MPS account, the sender third party MPS account being on the sender third party payment system and being one of the plurality of third party MPS accounts;
waiting for a confirmation of the first transfer;
after the confirmation of the first transfer, initiating a second transfer of the transfer amount from a recipient third party MPS account to the recipient user account, the recipient third party MPS account being on the recipient third party payment system and being one of the plurality of third party MPS accounts.

14. The mobile payment system method of claim 12, wherein when the sender user account is a sender third party user account on a sender third party payment system identified by the sender payment method, and the recipient user account is a recipient third party user account on the sender third party payment system identified by the recipient payment method, the steps of transferring the transfer amount from the sender user account and transferring the transfer amount to the recipient user account comprise:
initiating a first transfer of the transfer amount from the sender user account to a sender third party MPS account, the sender third party MPS account being on the sender third party payment system and being one of the plurality of third party MPS accounts;
waiting for a confirmation of the first transfer;
after the confirmation of the first transfer, initiating a second transfer of the transfer amount from the sender third party MPS account to the recipient user account.

15. The mobile payment system method of claim 1, wherein the MPS functions include an event function for an organizer of the plurality of MPS users to invite one or more invitees, each of the invitees being one of the plurality of MPS users, and the method further comprising:
displaying an event organizer interface on the MPS frontend associated with the organizer;
enabling the organizer to enter an event name, an event description and an event amount using the event organizer interface;
enabling the organizer to build an invitee list using the event organizer interface;
enabling the organizer to submit a request to send invitations from the event organizer interface on the MPS frontend associated with the organizer to the MPS backend; along with the event name, the event description, the event amount, and the invitee list;
establishing an event MPS account on the MPS backend;
sending an invitation from the MPS backend to the MPS frontend associated with each of invitees on the invitee list, the invitation including the event name, the event description and the event amount;
for each invitee, displaying the invitation along with an invite accept selection and an invite decline selection on the MPS frontend associated with the invitee;
if the invitee selects the invite accept selection; sending an invite accept notice from the invitee frontend to the MPS backend, initiating a funds transfer from the MPS user account associated with the invitee to the event MPS account, and sending an acceptance notice for the invitee to the MPS frontend associated with the organizer;
if the invitee selects the invite decline selection; sending an invite decline notice from the invitee frontend to the MPS backend, and sending a decline notice for the invitee to the MPS frontend associated with the organizer.

16. The mobile payment system method of claim 1, wherein the MPS functions include a payment request for a paying MPS user to pay a recipient, the payment request function comprising:
displaying a payment interface on the MPS frontend associated with the paying MPS user;
enabling the paying MPS user to enter a recipient identifier, a payment amount and a payment method into the payment interface;
enabling the paying MPS user to submit the payment request by sending the recipient identifier, the payment amount and the payment method from the MPS frontend associated with the paying MPS user to the MPS backend;
enabling the paying MPS user to request an MPS loan;
if the paying MPS user requests an MPS loan, then:
determining a recipient based on the recipient identifier;
determining whether to offer an MPS loan or deny the MPS loan request based on the recipient, the payment amount and profile information associated with the paying MPS user;
if it is determined to deny the MPS loan request, notifying the paying MPS user of denial of the MPS loan request;
if it is determined to offer an MPS loan in response to the MPS loan request, then:
determining loan interest rate, origination fee, monthly payment amount, number of monthly payments, and terms and conditions based on the recipient, the payment amount and profile information associated with the paying MPS user;
notifying the paying MPS user of the MPS loan offer along with the loan interest rate, origination fee, monthly payment amount, number of monthly payments, and terms and conditions of the MPS loan offer;
if the paying MPS user accepts the MPS loan offer, then initiating a first funds transfer of the payment amount directly to the recipient, and initiating a second funds transfer of the origination fee from a user account associated with the paying MPS user to the MPS bank account or one of the plurality of third party MPS accounts.

17. The mobile payment system method of claim 16, wherein if the paying MPS user accepts the MPS loan offer, the method further comprises:
setting up a monthly recurring payment of the monthly payment amount from the user account associated with the paying MPS user to the MPS bank account or one of the plurality of third party MPS accounts to occur each month for the number of monthly payments.

18. A mobile payment system (MPS) that enables transactions for a plurality of MPS users using a plurality of user electronic devices, where the mobile payment system interfaces with a plurality of third party payment systems that have a plurality of third party user accounts; the mobile payment system comprising:
a plurality of MPS frontends, each of the MPS frontends being located on one of the plurality of user electronic devices, and each of the MPS frontends being associated with one of the MPS users;
a plurality of third party MPS accounts, at least one of the third party MPS accounts being on each of the third party payment systems;
a MPS backend comprising a MPS backend account, a MPS database and a plurality of MPS user accounts, each of the MPS user accounts being associated with at least one of the MPS users;
wherein any particular MPS frontend of the plurality of MPS frontends is located on a particular user electronic device of the plurality of user electronic devices, the particular MPS frontend performs local processing of MPS functions on the particular user electronic device and communicates over a network with the mobile payment system backend and with other MPS frontends of the plurality of MPS frontends on other user electronic devices of the plurality of user electronic devices; and
wherein the MPS backend administers funds in the MPS backend account, the plurality of MPS user accounts, and the plurality of third party MPS accounts.

19. The mobile payment system of claim 18, wherein each of the plurality of MPS user accounts on the MPS backend is associated with at least one of the third party user accounts on the third party payment systems.

20. The mobile payment system of claim 18, wherein the MPS database includes authentication data for each of the MPS users, and the authentication data for a certain MPS user of the plurality of MPS users is based on a mobile phone number associated with a certain user electronic device of the plurality of user electronic devices where the MPS frontend associated with the certain MPS user is located on the certain user electronic device.
